(19) United States
(12) Patent Application Publication
(10) Pub. No.: US 2009/0073069 A1
(43) Pub. Date: Mar. 19, 2009

(54) Robust communications antenna

(76) Inventors: Gregory M. Quist, Escondido, CA (US); David A. Drake, Escondido, CA (US)

Correspondence Address: THE NATH LAW GROUP, 112 South West Street, Alexandria, VA, 22314, US

(21) Appl. No.: 12/222,139

(22) Filed: Aug. 4, 2008

Related U.S. Application Data
(60) Provisional application No. 60/963,740, filed on Aug. 7, 2007.

(51) Int. Cl. H01Q 9/04; H01P 11/00

(52) U.S. Cl. 343/791; 29/600

(57) ABSTRACT

A robust low profile antenna well suited for deployment on the lids of cavities, such as manholes is described. The antenna is constructed from a coaxial cable for use proximate to a structural surface. The antenna is formed by folding back an outer metallic braid of an end of the coaxial cable to a length that approximately matches ¼ of a wavelength of a desired operating frequency times a velocity factor of the coaxial cable. Next, the radiative element is formed by exposing the center conductor from the end of the coaxial cable to a length that approximately matches ¼ of the wavelength of the operating frequency multiplied by the composite velocity factor being based on a dielectric encasing of the coaxial cable and the distance of the antenna from the structural surface. The antenna is oriented substantially parallel to the structural surface. The resulting antenna is of a comparable size to the coaxial cable.

### CROSS-REFERENCE TO RELATED APPLICATIONS

This application claims the benefit of U.S. Provisional Patent Application No. 60/963,740, filed Aug. 7, 2007, the contents of which are hereby incorporated by reference in its entirety.

### BACKGROUND OF THE INVENTION

1. Field of the Invention

The present application relates to methods and apparatuses for communications, and, in particular, to methods and apparatuses for a robust antenna system/design capable of operating in environmentally hostile conditions.

2. Related Art

Antennae are used for a wide range of radio communications applications and are often deployed in places where they can be damaged. In many antenna applications the radiative element of the antenna is placed at right angles, often vertical, to a structural surface. The intent is to create a dipole radiator by the reflection of a driven element from a conductive metallic surface. This is commonly seen in roof top mounting of radio antennae on vehicles. Such antennae are successful, but are prone to damage by vandals and common usage. In some cases it is not possible to mount a right angle antenna on a metallic surface. A good example is an antenna for a manhole or utility vault cover. Such an antenna is continuously challenged by traffic impacts. A common approach is to mount the antenna in a manner that is in parallel with a structural surface. This provides superior defense against damage, but often compromises its electromagnetic performance.

What is desired is an antenna configured to provide effective operation about a manhole or utility vault cover while providing robust survival characteristics.

### SUMMARY OF THE INVENTION

The present subject matter addresses the above concerns by disclosing an antenna design that incorporates both good electromagnetic performance and resistance to damage. Such an antenna can be installed on metallic or non-metallic enclosures, utility vault covers, manhole covers, equipment cases, walls, roofs, flagpoles, light poles, electrical and other utility poles, doors, windows, vehicle surfaces, back packs, cell phone cases, personal communications device cases, military equipment, munitions, aircraft hulls, ship hulls, security devices, safes, and other structural surfaces. Note that such an antenna can be used to transmit, receive or both functions for radio communications. Such an antenna can also be used for radar and synthetic aperture radar applications.

Various aspects of the present subject matter are disclosed, including a method for constructing an antenna from a coaxial cable for use proximate to a structural surface, comprising the steps of folding back an outer metallic braid of an end of the coaxial cable to a length that approximately matches ¼ of a wavelength of a desired operating frequency times a velocity factor of the coaxial cable; forming a radiative element by exposing a center conductor from the end of the coaxial cable to a length that approximately matches ¼ of the wavelength of the operating frequency multiplied by a composite velocity factor being based on a dielectric encasing of the coaxial cable and a distance of the antenna from the structural surface; and orientating the antenna substantially parallel to the structural surface, wherein the antenna that is formed is of a comparable size to the coaxial cable.

In yet another aspect of the present subject matter, there is disclosed an antenna formed from a coaxial cable for use proximate to a structural surface, comprising: a coaxial cable; an outer metallic braid of an end of the coaxial cable having been folded back to a length that approximately matches ¼ of a wavelength of a desired operating frequency times a velocity factor of the coaxial cable; an exposed center conductor at the end of the coaxial cable having a length that approximately matches ¼ of the wavelength of the operating frequency multiplied by a composite velocity factor being based on a dielectric encasing of the coaxial cable and a distance of the antenna from the structural surface; and operating an orientation of the antenna substantially parallel to a structural surface.

### BRIEF DESCRIPTION OF THE DRAWINGS

The features, nature, and advantages of the presently disclosed methods and apparatuses will become more apparent from the detailed description set forth below when taken in conjunction with the drawings in which like reference characters identify corresponding items throughout.

FIG. 1 is a schematic illustration of an apparatus for generating power in an enclosure according to the present disclosure;

FIG. 2 illustrates an operational environment for an apparatus for generating power in an enclosure according to the present disclosure;

FIG. 3 illustrates an apparatus for generating power in an enclosure utilizing a temperature difference between two areas of the enclosure according to the present disclosure;

### DETAILED DESCRIPTION

In the following detailed description, reference is made to the accompanying drawings, which form a part hereof, and in which are shown by way of illustration specific embodiments in which the subject matter may be practiced. In this regard, terminology such as “first,” “then,” “afterwards,” “before,” “next,” “finally,” “above,” “below,” “top,” “bottom,” “front,” “back,” “leading,” “trailing,” etc., is used with reference to the drawing being described. Because the processes and methods of the present subject matter can be performed in a number of different orders, and because the individual elements of the apparatus and systems of the present subject matter may be configured in a number of different orders, the above terminology is used for purposes of illustration and is in no way limiting. It is to be understood that other embodiments may be utilized and logical changes may be made without departing from the scope of the present subject matter. The following detailed description, therefore, is not to be taken in a limiting sense, and the scope of the present subject matter includes the full scope of the appended claims.

Although a number of discrete embodiments are described below, it is to be understood that these are merely non-limiting examples, and that any given embodiment of the subject matter may comprise some of the features of one shown embodiment, and/or some of the features of another shown embodiment. In the charts presented herewith, optional steps are illustrated in dashed lines. Other modifications between embodiments will be clear to one skilled in the art upon reading the following disclosure.

The present subject matter differs significantly from the typical dipole antenna. In particular, coaxial cable components are primarily used to form the antenna. As such, the antenna is an integral part of the coaxial cable. Further, by implementation of the various embodiments disclosed herein, the exemplary antenna is understood to demonstrate superior or at least improved electromagnetic performance over conventional or similar antennas.

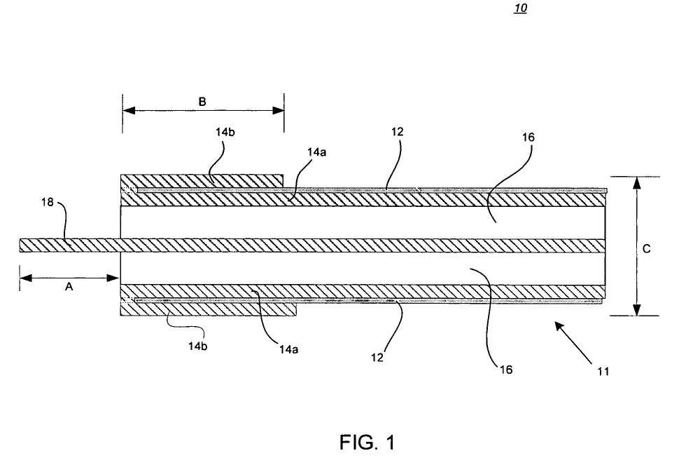

FIG. 1 is an illustration of an exemplary antenna 10. The exemplary antenna 10 is generated by modifying a related art “bazooka” antenna. Bazooka antennas are usually formed as a dipole, however, the exemplary antenna 10 is illustrated in FIG. 1 with a monopole configuration. Of course, based on the description provided herein, the monopole configuration can be easily adapted for to a dipole configuration by appropriate adjustments, well-known to those in the antenna arts.

The exemplary antenna 10 is formed by taking a piece of coaxial cable 11 and folding back the outer conductive shield 14a along the outer insulator 12. The exposed length of the inner conductor is called the antenna probe 18. The folded back outer shield 14b provides a “balanced” to “unbalanced” transformer and reduces currents along the shield 14a-b. This also provides a degree of impedance matching from the coax 11 to the antenna probe 18. The resulting antenna 10 and the coax 11 both have similar characteristic impedances, thereby improving efficiency in the transition from the transmission line aspect of the coax 11 to the radiating aspect of the antenna 10. The probe 18 and folded back shield 14b can also be protected by coating them with a dielectric material (not shown), as according to design preference.

It is known that the length B of the folded back shield 14b section is governed by the velocity factor of the coaxial cable 11. Typical velocity factors vary by type of coaxial cable and usually range from 0.6 to 0.9 times the speed of light in a vacuum. In the case of, for example, RG316 coaxial cable a typical velocity factor is approximately 0.8. Thus, the length B of the folded back shield 14b section is approximately ¼ wavelength of the operating frequency, multiplied by the velocity factor.

The length A of the probe 18 is similarly determined by the velocity factor of the probe 18, in concert with the dielectric 16 adjacent to the probe 18 and the distance C to the metallic surface(s) of the folded back shield 14b. This velocity factor can be considered a composite velocity factor, being derived from both the dielectric 16 and the distance C. The composite velocity factor is closer to, but slightly less than 1. A typical value is near 0.93. Thus the length A of the probe 18 is approximately ¼ of the operating frequency wavelength multiplied by approximately 0.93. This value can also vary due to the dielectric constant of the protective covering 12 and the distance C to the metallic surface of the folded back shield 14b.

With respect to this last observation, while the distance C is illustrated as reaching the outer diameter of the metallic surface of the folded back shield 14b, it is subject to contributions from the adjacent (not folded back) shield 14a “under” the folded back shield 14a and to contributions from the protective covering 12. Thus, the actual effective distance C may be adjusted to be slightly less or greater than shown. This effective distance can be precisely evaluated using closed form or computational methods or empirically evaluated. In view of the forgoing, by adjusting the various physical parameters of the exemplary antenna 10, and measuring its performance, a specialized antenna that is robust and well suited for applications described herein can be empirically arrived at.

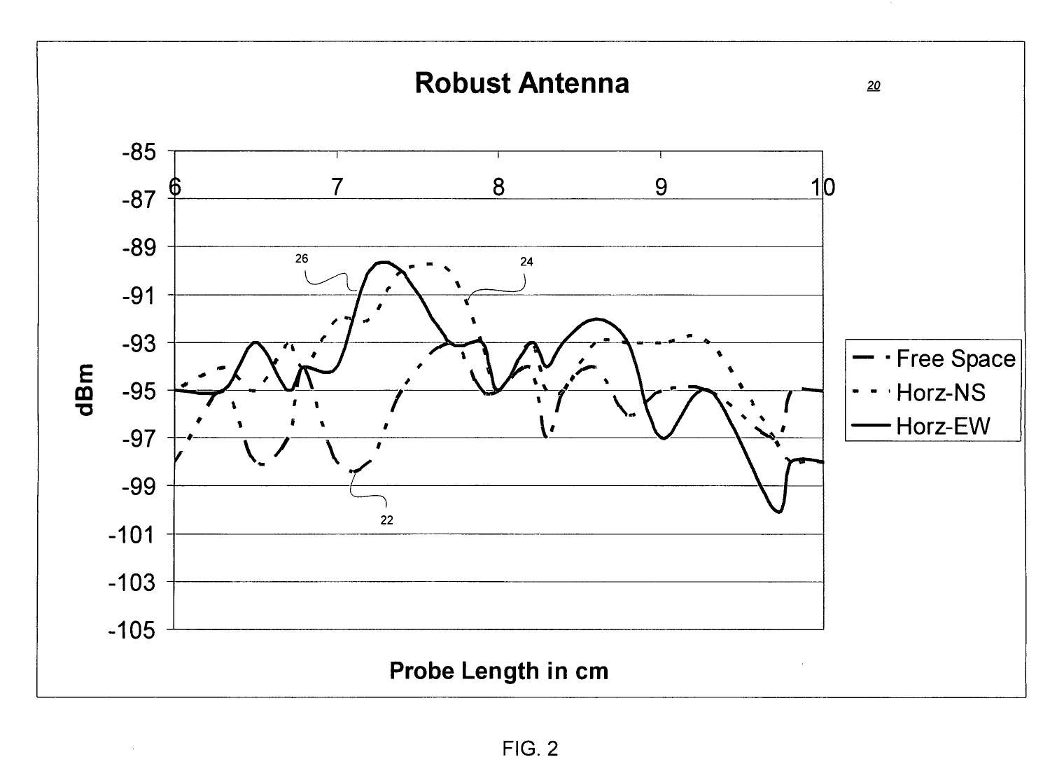

FIG. 2 is a performance plot 20 of the exemplary antenna 10 as a function probe length and received signal strength from a local ground based transceiver. In this example, the length B of the exemplary antenna's 10 folded back shield section 14b is 6.5 cm long and the length A of the probe 18 is varied from 6 cm to 10 cm using a high density polyethylene dielectric sleeve. The exemplary antenna 10 is elevated approximately 5 mm above a metal surface, in this instance being a cast iron surface. FIG. 2 shows the received signal strength as the length A of the antenna probe 18 is varied above and below the baseline 7.5 cm length, while operating the antenna at a frequency of approximately 940 MHz.

Three performance plots are shown: the response of a Free Space dipole 22 used as a baseline, the exemplary antenna 10 oriented at Horizontal North-South 24, and oriented Horizontal East-West 26. FIG. 2 clearly shows how the exemplary antenna 10 outperforms the received signal strength of the Free Space dipole 22 for either the North-South 24 configuration or the East-West configuration 26. Of particular note are the peaks of the North-South 24 curve and the East-West 26 curve between 7-8 cm. Thus, FIG. 2 shows one or more enhanced performance characteristics of the exemplary antenna 10 for a given length A of the probe 18.

It is understood that generally, a dipole antenna is somewhat directional. Therefore, while FIG. 2 attempts to account for the directionality of the Free Space dipole 22 by comparing both a North-South and East-West orientation of the exemplary antenna 10, further enhancement of the exemplary antenna's received signal strength can be achieved by altering the position of the exemplary antenna 10 above its surface. That is, by tilting one end of the exemplary antenna 10 up to 30 degrees above its surface, a gain in its directivity can be accomplished. Thus, rather than utilizing a wholly horizontal exemplary antenna 10, a non-horizontal or angled exemplary antenna 10 may be used, with respect to the underlying surface, to provide additional gains in the received signal strength. Methods for increasing directivity are well known in the antenna arts and are therefore not further elaborated herein.

It is also noted that as a variation of the deployment of the exemplary antenna 10, a variety of polymers and distances between the exemplary antenna 10 and the structural surface can be used, with concomitant velocity factors generated, resulting in concomitant antenna probe lengths. This allows for flexibility when designing the exemplary antenna 10 for different uses, frequencies, and bandwidth. Accordingly, for the case of mounting the exemplary antenna 10 on a non-metallic surface, the probe 18 section is understood to have a velocity factor closer to 1.0, so the probe length A will be approximately ¼ of the wavelength of the operating frequency. Accordingly, modifications to the probe length A, using different frequencies, different heights above a surface/type of surface and other exemplary antenna 10 related factors may be practiced without departing from the spirit and scope of this disclosure. Therefore, multiple exemplary antennas 10 may be devised for specific deployment scenarios, all configured to provide superior and/or enhanced performance over other bazooka-like antennas.

As should be apparent from this description, an advantage of this exemplary antenna 10 over other antennas is that the resulting antenna diameter is only slightly larger in diameter than the original coaxial cable. Thus both the exemplary antenna 10 and the coaxial cable 11 can be fed through a small diameter hole for easy mounting. A coaxial connector can be pre-installed on the coaxial cable 11 and does not have to go through the mounting hole. Thus, the through hole can be of very limited diameter. For example, a ⅛″ diameter coaxial cable, such as RG316 and its corresponding exemplary antenna 10, can be fed through a 3/16 inch hole. The coaxial connector on such a cable could be, as a non-limiting example, an SMA connector that would normally require a ⅜ inch hole. Thus mounting the exemplary antenna 10 on a structural surface (e.g., ground plane or thick piece of metal) would be much easier as the hole diameter is ½ the size, requiring far less effort to drill the hole through the material. The coaxial cable connector could also on one side of the structural surface.

Yet another advantage of this exemplary antenna 10 is that there is a wide variety of mounting options. For example, it can be mounted with an adhesive onto a structural surface such as, for example, a dielectric like glass, plastic, or fiberglass, or a metallic surface such as aluminum or cast iron such as a manhole cover, and so forth. The structural surface may be magnetic or non-magnetic and may also operate as a ground plane. It may also be mounted such that the exemplary antenna 10 and the protective dielectric is flush within a cavity in the structural surface. Mounting the exemplary antenna 10 flush with the structural surface provides extra protection against blows, traffic, or environmental conditions that could damage the antenna. The exemplary antenna 10 may also be fed through a hole in the structural surface where the radiating portion of the exemplary antenna 10 is positioned on one side of the structural surface while the non-radiating portion (e.g., coaxial cable) may be on the other side of the structural surface. In some instances, the coaxial cable portion may be affixed to the structural surface or stabilized from movement by some attachment means.

It should be understood that in some instances, the structural surface may be a ground plane in the classic antenna sense of the word. That is, the structural surface may operate as an imaging surface for electromagnetic fields/currents. Therefore, the term structural surface, depending on its context, may refer to an imaging surface or any surface that provides imaging capabilities. In some instances, the structural surface may be a ground plane with a secondary surface “below” it, for example, a ground plane above a manhole cover. Thus, there may be two or more structural surfaces, one operating as a ground plane and the other operating as a surface to “attach” the exemplary antenna 10. As should be apparent to one of ordinary skill in the art, the use and implementation of ground planes with antennas are well known and therefore are not further elaborated herein.

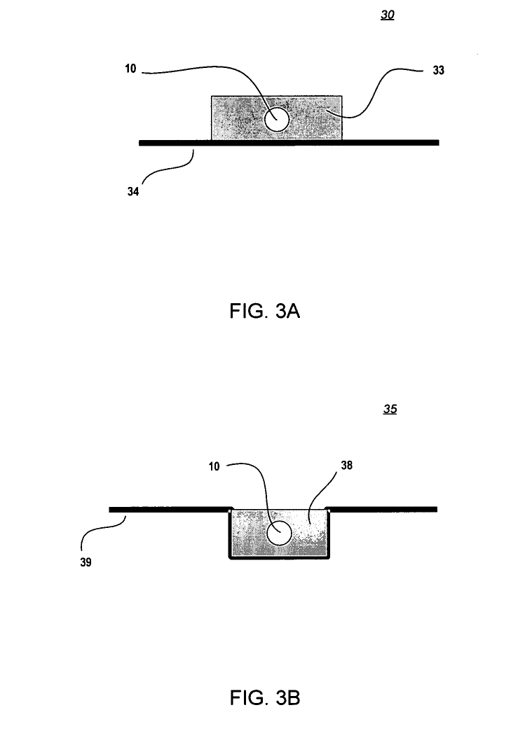

FIGS. 3A-B are cross-sectional illustrations showing various deployment scenarios for the exemplary antenna 10. FIG. 3A illustrates the deployment 30 of the exemplary antenna 10 above a planar structural surface 34. The exemplary antenna 10 is encased in a dielectric material 33 or non-metallic material operating as a protective shield 33 for the exemplary antenna 10. The shield 33 may be formed of a fluid polymer material that hardens and adheres to the structural surface 34. The shield 33 may be of an arbitrary shape, therefore, it is not constrained to the rectangular form shown in FIGS. 3A-B. For example, it may be curved or hemispherical, and so forth. As discussed above, the shield 33 may be affixed to the structural surface 34 by means of an adhesive or other similar or non-similar mechanism for attachment.

FIG. 3B illustrates another deployment scenario 35, wherein the exemplary antenna 10 is placed within a cavity of the structural surface 39. Here, the primary difference from the embodiment shown in FIG. 3A is that the structural surface 39 in a non-planar surface. By matching the shield 38 with the cavity of the structural surface 39, the exemplary antenna 10 with its shield 38 can be configured to form a flush surface. Thus, the overall profile renders this configuration less prone to traffic damage. As should be apparent, the non-planar surface need not be rectangular, and it may not be necessary to have the shield's shape match, per se, the shape of the cavity. In some instances, the shape of the shield 38 may be curved or of such a volume that only a portion of cavity is filled with the shield 38. As discussed above, the shield 38 may be affixed to the structural surface 39 by means of an adhesive or other similar or non-similar mechanism for attachment.

It should be noted that the exemplary antenna 10 of FIGS. 3A-B may be positioned in a slightly non-horizontal orientation above the structural surface 34 and 39, altering in some respects, the directivity of the exemplary antenna 10. That is, in some embodiments, the exemplary antenna 10 may be positioned in a non-parallel orientation, depending on design and performance objectives. It should also be apparent that the exemplary antenna 10's coaxial portion (i.e., non-radiating portion) may be shielded or disposed away from the radiating portion (i.e., probe) by placing the coaxial portion of the exemplary antenna 10 through a hole (not shown) in the structural surface 34 and 39. The implementation of a hole in a structural surface 34 and 39 to separate the radiating part of an antenna from the feed part of the antenna is a well understood concept and, therefore, not further elaborated herein. As discussed above, a ground plane (not shown) may also be used in addition to the structural surface 34 and 39. By design and implementation of the various features described herein for a robust antenna having a low profile, it is possible to fabricate an antenna that is well suited for deployment in a manhole cover or lid. Specifically, the robust antenna lends itself very well to satisfying the requirements of a low form factor antenna that can be easily mated to a manhole cover or lid or other environmental enclosure, without undue modification of the supporting structure and also providing a significant degree of robustness when combined with a shield.

The previous description of some aspects is provided to enable any person skilled in the art to make or use the presently disclosed methods and apparatuses. Various modifications to these aspects will be readily apparent to those skilled in the art, and the generic principles defined herein may be applied to other aspects without departing from the spirit or scope of the inventive subject matter. For example, one or more elements can be rearranged and/or combined, or additional elements may be added. Thus, the present inventive subject matter is not intended to be limited to the aspects shown herein but is to be accorded the widest scope consistent with the principles and novel features disclosed herein.

What is claimed is:

1. A method for constructing an antenna from a coaxial cable for use proximate to a structural surface, comprising:
folding back an outer metallic braid of an end of the coaxial cable to a length that approximately matches ¼ of a wavelength of a desired operating frequency times a velocity factor of the coaxial cable;
forming a radiative element by exposing a center conductor from the end of the coaxial cable to a length that approximately matches ¼ of the wavelength of the operating frequency multiplied by a composite velocity factor being based on a dielectric encasing of the coaxial cable and a distance of the antenna from the structural surface; and
orientating the antenna substantially parallel to the structural surface, wherein the antenna that is formed is of a comparable size to the coaxial cable.

2. The method according to claim 1, wherein the orientation of the antenna is up to 30 degrees from parallel from the structural surface.

3. The method according to claim 1, further comprising mounting the antenna to the structural surface by passing it through a hole in the structural surface.

4. The method according to claim 3, wherein the radiative element of the antenna is positioned on an opposite side of the structural surface from a coaxial connector.

5. The method according to claim 1, wherein the antenna is encased in a dielectric protective holder that holds the antenna in a fixed position above the structural surface.

6. The method according to claim 5 wherein the dielectric protective holder is formed by coating the antenna with a fluid polymer material that hardens and adheres to the structural surface.

7. The method according to claim 1, wherein the antenna is mounted flush with the structural surface.

8. The method according to claim 1, wherein the structural surface is formed of a dielectric.

9. The method according to claim 1, wherein the structural surface is a ground plane.

10. The method according to claim 1, wherein the structural surface is magnetic.

11. An antenna formed from a coaxial cable for use proximate to a structural surface, comprising:
a coaxial cable;
an outer metallic braid of an end of the coaxial cable having been folded back to a length that approximately matches ¼ of a wavelength of a desired operating frequency times a velocity factor of the coaxial cable;
an exposed center conductor at the end of the coaxial cable having a length that approximately matches ¼ of the wavelength of the operating frequency multiplied by a composite velocity factor being based on a dielectric encasing of the coaxial cable and a distance of the antenna from the structural surface; and
an orientation of the antenna substantially parallel to a structural surface for operating thereof.

12. The antenna according to claim 11, wherein the operating orientation of the antenna is up to 30 degrees from parallel from the structural surface.

13. The antenna according to claim 11, wherein the antenna is mounted to the structural surface by passing it through a small hole in the structural surface.

14. The antenna according to claim 11, wherein the exposed center conductor is on one side of the structural surface and a coaxial connector is on the other side of the structural surface.

15. The antenna according to claim 11, further comprising a dielectric protective holder that encases the antenna and holds the antenna in a fixed position above the structural surface.

16. The antenna according to claim 11, wherein the dielectric protective holder is formed by coating the antenna with a fluid polymer material that hardens and adheres to the structural surface.

17. The antenna according to claim 11, wherein the antenna is mounted flush with the structural surface.

18. The antenna according to claim 11, wherein the structural surface is dielectric.

19. The antenna according to claim 11, wherein the structural surface is a ground plane.

20. The antenna according to claim 11, wherein the structural surface is magnetic.
